(19) United States
(12) Patent Application Publication
(10) Pub. No.: US 2003/0127857 A1
(43) Pub. Date: Jul. 10, 2003

(54) Manually actuated mechanical locking swivel

(75) Inventors: Harper Boyd, Lake Charles, LA (US); Anthony Ray Boyd, Loreauville, LA (US)

Correspondence Address: W-H ENERGY SERVICES, INC., 10370 RICHMOND AVENUE, SUITE 990, HOUSTON, TX, 77042, US

(73) Assignee: Boyd's Bit Service, Inc., Lake Charles, LA

(21) Appl. No.: 10/367,988

(22) Filed: Feb. 14, 2003

Related U.S. Application Data
(63) Continuation of application No. 09/498,188, filed on Feb. 4, 2000.

(51) Int. Cl. F16L 25/00; F16L 35/00

(52) U.S. Cl. 285/330

(57) ABSTRACT

A locking swivel apparatus including an upper body portion having a counter bore about a cylindrical axis and a mandrel having an upper end receivable in the counter bore. The locking swivel also includes a lower cap member engaged with the upper body portion and disposed to secure the upper end of the mandrel in the counter bore. The locking swivel further includes an internal locking arrangement including a plurality of mating axial teeth configured to selectively couple and decouple the upper body portion and the mandrel. The selective coupling and decoupling disposed to correspondingly constrain and allow relative rotation of the upper body portion and the mandrel about the cylindrical axis. Methods are provided for fabricating embodiments of the present invention.

### RELATED APPLICATIONS

This application is a continuation of co-pending, commonly-assigned U.S. patent application Ser. No. 09/498,188 entitled MECHANICAL LOCKING SWIVEL APPARATUS, filed Feb. 4, 2000.

### TECHNICAL FIELD OF THE INVENTION

The apparatus of the present invention relates to locking swivels. More particularly, the present invention relates to an improved mechanical locking swivel positionable above the rig floor for allowing the reorientation of a bent sub during a directional drilling without having to withdraw a wireline that has been located within the drill string from above the rig floor.

### BACKGROUND OF THE INVENTION

In the drilling of oil wells, one of the more frequent types of wells that are drilled are directional wells. Rather than have to drill a well vertically, often times because of the location of the pocket of hydrocarbons, or for other reasons, the direction of the well has to be altered or done in a direction off of the vertical and is termed a directional well. This is accomplished with the use of a type of a bent sub, which is placed on the lower end of the drill string and the drill bit is rotated downhole via a motor known as a dynadrill. The bent sub, when it is oriented in a particular pre-determined orientation, will have the bit drill travel in that particular orientation as a directional well.

Quite often in the drilling process, the direction of the drill bit has been mis-oriented and has to be adjusted slightly in order to reorient the bit in the proper direction. In most cases, this can easily be accomplished by setting the drill string via the slips, and rotating the rotary table slightly so that the entire drill string is re-oriented and then drilling can resume at that orientation. However, in the instance when there is a wireline which has been fed down into the drill string, because the wireline is usually fed through a side entry sub apparatus, the string cannot be rotated due to the fact that that would put stress on the wireline itself, which may result in the wireline being cut and the tool at the end of the wireline could be lost within the well bore, which would result in the tool having to be retrieved if possible. This is time consuming and expensive and requires that the well be shut down in order to do so. However, in the current state of the art, in order to reorient the drill bit while a wireline is downhole, the tool at the end of the wireline has to be retrieved from the well. Next, the drill string has to be reoriented in the proper direction and then the wireline would be re-fed down into the drill string for undertaking its work downhole. Again, this is time consuming and results in loss of rig time. There are also devices known in the industry, which attempt to provide a means by which the drill string can be oriented without having to orient the upper portion of the drill string above the rig floor where the wireline is being fed. These types of tools are known as swivels, and to some extent are successful to a certain point.

There currently is issued U.S. Pat. No. 5,996,712, entitled “Mechanical Locking Swivel Apparatus,” which provided for a pair of pin members to engage the teeth of a second portion of the apparatus in order to lock the mandrel in place. Each of the pin members was set within a bore in the body of the tool, so that the pin could extend into the bore of the upper portion to engage the mandrel. It has been determined that this particular arrangement lends itself to a weakening of the upper tool body, and does not accomplish the task of the tool in the most favorable fashion. Therefore, applicant has attempted to solve this problem with the improved mechanical swivel apparatus as will be discuss and claimed in the present application.

### SUMMARY OF THE INVENTION

The apparatus of the present invention solves the shortcomings in the art in a simple and straightforward manner. What is provided is an improved mechanical swivel apparatus which has a first upper body portion threadably attached to the lower end of a side entry sub apparatus, and a second lower portion which is threadably attached to a section of drill pipe, the apparatus positionable above the rotary table on the rig floor, and having a continuous bore therethrough for running wireline or the like. The upper body portion includes a counterbore for receiving the upper end of a mandrel, so that the mandrel is able to move within the counterbore of the upper body portion. The lower portion comprises an open-ended cap member, which threadably engages the upper body portion, and has a shoulder portion, which engages a flange around the body of the mandrel so that the mandrel is allowed to move within the upper body portion but cannot be slidably removed therefrom. On its upper end, the mandrel portion further includes a plurality of outwardly extending teeth which define spaces there between, so that a plurality of teeth extending into the counterbore of the upper body portion, at a first position, lockingly engage between the teeth on the mandrel portion so that the mandrel portion is locked in place with the body portion. In a second position, the teeth on the mandrel are slidably moved out of engagement with the teeth on the upper body member, allowing the mandrel, and the drill string below the mandrel to move freely.

In operation, the teeth of the upper body portion are engaged within the inner spaces between the teeth in the mandrel so that when the upper body portion is rotated, the mandrel is rotated, and in a second position the teeth of the upper body portion are disengaged from the teeth of the mandrel portion, so that the mandrel portion can remain stationary while the upper body portion is rotated. There is further included a plurality of seals and the like for sealing off the engagement of the surfaces between the moving parts of the body portions and the mandrel so that any fluid being flowed down through the bore in the tool is prevented from leaking out of the apparatus.

Therefore, it is a principal object of the present invention to provide a mechanical swivel apparatus which provides an upper body portion engaged to a lower mandrel portion, through interlocking teeth formed on the outer face of the mandrel and the inner face of the upper body portion, so that the integrity of the walls of the body portion and the mandrel portion is not comprised through pins inserted into bores in the wall or the like.

It is a further principal object of the present invention to provide an improved mechanical swivel apparatus, which mechanically engages and disengages so that the drill string below the apparatus can be rotated while the portion of the drill string above the apparatus remains stationary.

It is a further principal object of the present invention to provide an improved mechanical swivel apparatus which provides for an upper body portion to mechanically engage a lower mandrel portion so that the drill string below the apparatus can be rotated while the portion of the drill string above the apparatus is rotated, the mechanical engagement allowing optimum strength in the body portion and the mandrel portion during engagement.

It is a further object of the present invention to provide a mechanical swivel apparatus which is inserted along the drill string between an upper side entry sub through which wireline is fed, and the lower drill string, so that when the lower drill string must be rotated in order to properly orient the drill bit, the tool body can be placed in the disengaged position and the upper portion, including the side entry sub with the wireline, remains stationary, while the drill string is rotated to the proper orientation.

It is a further object of the present invention to provide an apparatus positioned within the drill string above the rig floor which provides a mechanism to allow rotation of the drill string below the apparatus and to provide that the portion of the drill string above the apparatus remain stationary during wireline operations if orientation of the drill bit is necessary.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates an overall view of the preferred embodiment of the apparatus of the present invention within a drill string.

FIG. 2 illustrates an exploded view of the lower mandrel portion including the lower cap and brass collar member of the preferred embodiment of the apparatus of the present invention.

FIG. 3 illustrates an exploded view of the upper body portion of the preferred embodiment of the apparatus of the present invention.

FIG. 4 provides a cross section view of the preferred embodiment of the apparatus of the present invention in the engaged position.

FIG. 5 illustrates a cross section view of the apparatus of the present invention in the disengaged position.

### DETAILED DESCRIPTION

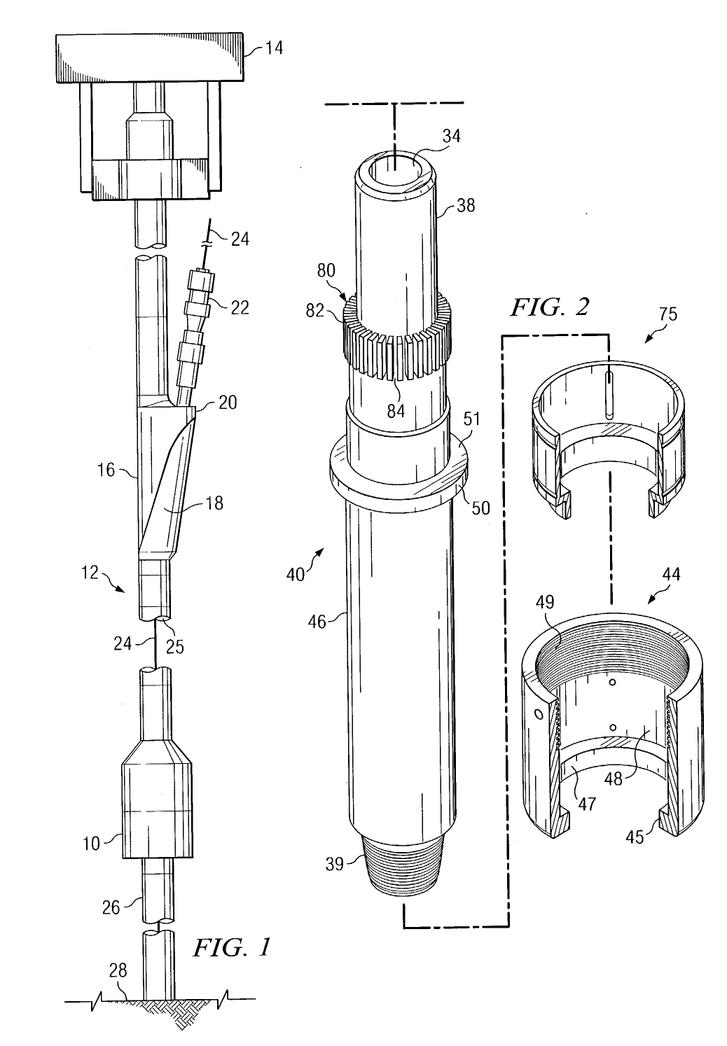

FIGS. 1 through 5 illustrate the preferred embodiment of the apparatus of the present invention by the number 10. As illustrated in overall view in FIG. 1, there is illustrated the mechanical swivel apparatus 10 placed with in a drill string assembly 12, the drill string as illustrated including an upper drive assembly 14, a side entry sub apparatus 16, of the type that is claimed and disclosed in U.S. Pat. Re 33,150, owned by Boyd's Bit Service, Inc., which, as illustrated includes a principal body portion 18, and an angulated portion 20 having an upper fixture 22 for feeding a wireline 24, as seen in partial view, down through a bore in the assembly 22 and principal body 18, and down through the bore 25 in the drill string assembly 12 as illustrated. The assembly 10, as illustrated, would be connected on its lowermost end to a section of drill pipe 26, which is seen being moved into or out of the drill hole at the level of the rotary table 28. In this particular embodiment, although not illustrated, on the lower end of the drill string there would be included a drill bit which would be operated by a dynadrill apparatus which is commonly known in the industry, and most likely there would be included a bent sub unit adjacent the dynadrill so that the drill bit would be drilling in a directional orientation.

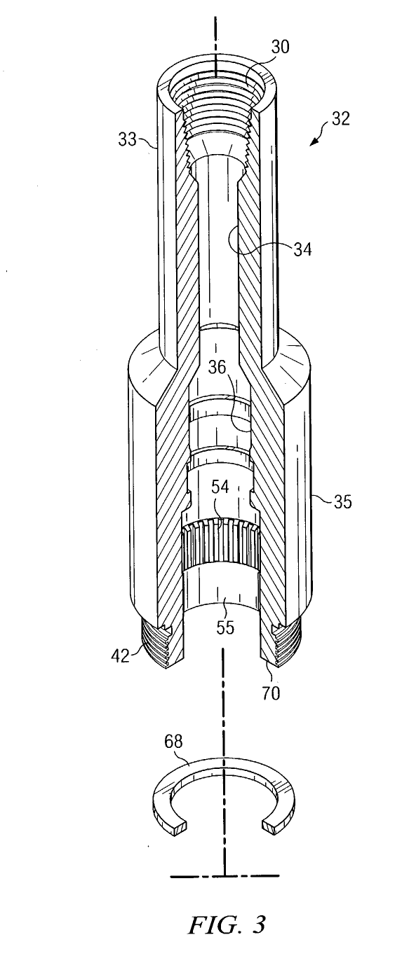

In discussing the particulars of apparatus 10 as illustrated in FIG. 1, reference is made to FIGS. 2-5. As illustrated, apparatus 10, as was discussed earlier, would be connectedly engaged on its upper portion to perhaps a sub 27, which may be a wear sub, which would be utilized in conjunction with the side entry sub apparatus 16. The sub 27 would be threadably engaged via threads 30 to the upper body portion 32 of the apparatus, through a pin and box connection (as illustrated on FIGS. 3, 4 and 5). With reference to FIG. 3, the upper body portion 32 would include a bore portion 34 which would be substantially the same size bore as the drill pipe 26 and the sub 27. The bore 34 of the upper body portion 32 would form an expanded counter bore area 36 for receiving the upper end 38 of a mandrel 40 (illustrated generally on FIG. 2), the purpose of which will be described further. As further illustrated on FIGS. 2 through 5, the lower end of the body portion 32 would form a pin and box threaded connection 42 to a lower cap member 44. Lower cap member 44, when threaded to the lower end of the body portion 32, provides a bore in which the mandrel travels, and includes a lower shoulder 45, the function of which will be described below.

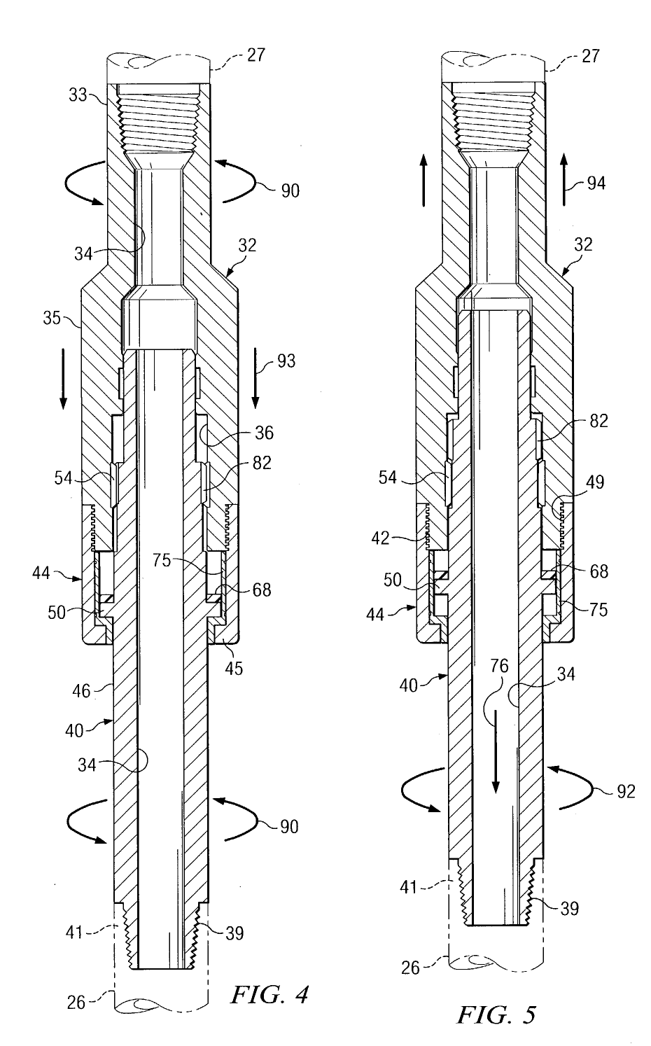

As further illustrated in FIG. 2, reference is made to mandrel 40, which as was stated earlier, includes the upper end 38 and the lower pin end 39, which would be threadably engaged to the box end 41 of drill pipe 26, as seen in FIGS. 4 and 5. Like body portion 32, mandrel 40 would also include a continuous bore 34 that would be basically continuous with the bore of the upper body portion 32 and cap 44. Mandrel 40 would include a continuous side wall 46 which would be of a diameter slightly less than the internal diameter 47 of the shoulder 45 formed by the lower end of cap portion 44, and including an angular flange 50 around its wall 46. As illustrated, after mandrel 40 has been inserted into the counter bore 36 of the upper body portion 32, the cap member 44 is threadably engaged to the lower end 42 of upper body portion 32 illustrated generally on FIG. 3. The threadable engagement between cap 44 and lower end 42 would be through a left hand thread rather than the normal right hand thread when threaded connections are made up. It should be noted that once cap member 44 is threaded in place, the annular flange 50 formed around the wall 46 of mandrel extends outward further than the opening 47 of the cap member 44, thus the mandrel 40 cannot become disengaged from within the counter bore 36 for the reasons as will be described further. As illustrated, mandrel 40, as was stated earlier, has a continuous wall 46 and a continuous bore 34 therethrough which would coincide with the continuous bore of body portion 32 for continuous flow of fluid down the drill string and allows the continuous movement of wireline a indicated by arrow 76 in FIG. 5. Further as illustrated on FIGS. 2 and 5, and was stated earlier, mandrel 40 includes the continuous annular flange 50, the upper surface of which 51 which rests against a Teflon® (E. I. DuPont de Nemour, Wilmington, Del.) member 68. Further, the mandrel includes a lower point end 39, which would threadably engage into a length of drill pipe 26. With reference now to FIG. 2, on the upper end of mandrel 40, there is included an engagement means 80. This engagement means 80 includes a plurality of spaced apart teeth members 82 defining spaces 84 therebetween. The spaces 84 would be slightly larger that the width of the teeth members 54 formed in the upper body portion 32 on FIG. 3, for the reasons as will be discussed further. As further illustrated in FIG. 2, the lower cap 44 is illustrated with its inwardly extending shoulder 45 from its continuous wall portion 48. The cap as was stated earlier includes a series of upper threads 49 which threadably engage to the lower end 42 of body 32, for the reasons as stated earlier. As further illustrated in FIGS. 2 and 5, there is a brass collar 75. Brass collar 75 would be slidably engaged within cap member 44 and would loosely fit against the wall 48 of cap member 44 so as to serve as a protective barrier between the mandrel 40 and the cap member 44 while the tool is at rest so as to help to prevent rust or the like from forming.

Reference is now made to FIG. 3, which illustrates the particular construction of the upper body portion 32. As was stated earlier, upper body portion 32 includes an upper neck portion 33, which is threadably engaged at threads 30 to a sub 27 as was seen in FIGS. 4 and 5. There is again as illustrated in FIG. 3, a continuous bore 34 through the body portion, which expands into an enlarged counter bore 36. As illustrated, the neck portion 33 then forms a thickened lower body portion 35 in which the counter bore 36 is formed, which then results in the lower threaded end 42 of the body portion 32, which would then threadably engage with cap member 44, which is illustrated in composite view in FIGS. 4 and 5. Continuing with FIG. 3, there is included a plurality of teeth 54 formed in the inner wall 55 of the lower body portion 32. There is further included a ring 68 formed of Teflon® or the like which would rest around a lower shoulder 70 of the lower body portion 35 so as to form a smooth mating surface between the ring 68 and the flange 50 of mandrel 40 during operation.

Reference now is made to FIGS. 4 and 5 for a discussion of the overall operation of the tool. As seen in FIG. 4, the mandrel 40 is in position within the counter bore 36 of body portion 32 and the mandrel is maintained within the opening 36 of body portion 32 via the cap portion 44 that has been engaged thereto. It is seen that the teeth 54 in the body portion 32 project into the counter bore 36, and are engaged within the spaces 84 formed between the teeth members 82 of the mandrel 40. In this position, the teeth 54 of body 32 are interlocked with teeth 82 of the mandrel 40, and the mandrel therefore, is locked in place with body portion 32 and cap 44, for example, while the drilling is taking place by the directional drill bit, and both the body portion 32 and mandrel 40 are rotating in unison as seen by arrows 90.

In the event that the drill bit needs to be reoriented, reference is made to FIG. 5, where the upper body portion 32 again is illustrated threadably engaged to the cap member 44 with the mandrel 40 secured within counter bore 36. However, in this position the teeth 82 of mandrel 40 have been moved out of alignment with the teeth 54 of the body portion 32, so that the mandrel 40 is free to rotate freely in the direction for example of arrow 92, without the upper body portion 32 and cap 44 rotating. This is accomplished by securing the section of drill pipe 26, which is projecting into the rotary table by the slips on the rotary table. Since the mandrel 40 is threadably secured to the now stationary drill pipe 26, as the upper portion of the tool is moved slightly downward in the direction of arrow 93 on FIG. 4, the teeth members 54 of the body 32 move out of alignment with teeth members 82 of the mandrel 40. When this is accomplished, the mandrel 40, together with the drill pipe 26 below the mandrel, is free to rotate while the upper body portion 32, and the assembly above it, remaining stationary. Referring momentarily to FIG. 1, the rotary table 28 can then be rotated the number of degrees necessary to properly align the drill bit without the upper portion of the tool 10 and anything above it, including the side entry sub 16, having to move. After the drill bit has been properly oriented, the upper portion of the drill string 26 (as seen on FIG. 5) is moved slightly upward in the direction of arrow 94 until the teeth 54 of body portion 32 are slidably re-engaged within the inner spaces 84 between teeth 82 of mandrel 40, so that the entire drill string now becomes stationary as one fixed string.

This improved mechanical locking swivel, which utilizes interlocking teeth between the mandrel 40 and body 32 results in a substantially stronger engagement between the two members, and by having the teeth formed on the inner wall of the body 32 and the outer wall of the mandrel 40, the walls of the two members are not compromised by through bores or the like, and are stronger in order to drive the drill string when the two members are engaged through the interlocking of the teeth.

Furthermore, this improved mechanical swivel apparatus, by allowing engagement and disengagement between portions of the apparatus through interlocking teeth, has allowed one portion of the apparatus to remain stationary while a second portion of the apparatus is movable. This gives the driller the ability to rotate that portion of the drill string below the upper portion of the apparatus without having to rotate the upper portion of the apparatus and anything above it at all. By doing this, this eliminates any potential problem that would arise should the side entry sub have to be rotated with the wireline engaged through it, which would put unneeded stress on the wireline and perhaps rupture it.

We claim:

1. A locking swivel apparatus comprising:
an upper body portion having a counter bore about a cylindrical axis, the upper body portion including a first threaded end distal from the counter bore;
a mandrel including an upper end, the upper end being receivable in the counter bore, the mandrel including a second threaded end distal from the upper end;
a lower cap member engaged with the upper body portion, the lower cap member disposed to secure the upper end of the mandrel in the counter bore;
an internal locking arrangement configured to selectively couple and decouple the upper body portion and the mandrel, said selective coupling and decoupling disposed to correspondingly constrain and allow relative rotation of the upper body portion and the mandrel about the cylindrical axis; and
the locking arrangement including a plurality of axial teeth disposed on an outer surface of the upper end of the mandrel and extending radially outward from the cylindrical axis and a plurality of axial teeth disposed in the counter bore of the upper body portion extending radially inward toward the cylindrical axis, the teeth disposed on the mandrel and the teeth disposed on the upper body portion being selectively engageable and disengageable with one another.

2. The locking swivel apparatus of claim 1, wherein said decoupling of the upper body portion and the mandrel is enabled by urging the mandrel deeper into the counter bore in a direction substantially parallel to the cylindrical axis.

3. The locking swivel apparatus of claim 2, further comprising manual actuation of said decoupling of the upper body portion and the mandrel.

4. The locking swivel apparatus of claim 1, wherein said coupling of the upper body portion and the mandrel is enabled by urging the mandrel out of the counter bore in a direction substantially parallel to the cylindrical axis.

5. The locking swivel apparatus of claim 4, further comprising manual actuation of said coupling of the upper body portion and the mandrel.

6. The locking swivel apparatus of claim 1, being coupleable to a drill string.

7. The locking swivel apparatus of claim 6, wherein the first threaded end is coupleable to an upper section of the drill string.

8. The locking swivel apparatus of claim 6, wherein the second threaded end is couplable to a lower section of the drill string.

9. The locking swivel apparatus of claim 1, wherein the lower cap member includes a left-hand thread for threadable engagement with the upper body portion.

10. The locking swivel apparatus of claim 1, wherein the mandrel further comprises a flange extending outward from an outer surface thereof.

11. The locking swivel apparatus of claim 10, wherein the flange abuts a lower face of the upper body portion when the upper body portion and the mandrel are in a decoupled position.

12. The locking swivel apparatus of claim 11, further comprising a ring member interposed between the flange and the lower face of the upper body portion.

13. The locking swivel apparatus of claim 10, wherein the flange abuts a shoulder portion of the lower cap member when the upper body portion and the mandrel are in a coupled position.

14. The locking swivel apparatus of claim 1, further comprising manual actuation of said selective coupling and decoupling of the upper body portion and the mandrel.

15. The locking swivel apparatus of claim 1, wherein said engagement of the teeth disposed on the mandrel and the teeth disposed on the upper body portion with one another enables said coupling of the upper body portion and the mandrel.

16. The locking swivel apparatus of claim 1, wherein said disengagement of the teeth disposed on the mandrel and the teeth disposed on the upper body portion with one another enables said decoupling of the upper body portion and the mandrel.

17. The locking swivel apparatus of claim 1, further comprising a brass sleeve disposed in the lower cap member.

18. A locking swivel apparatus comprising:
an upper body portion having a counter bore about a cylindrical axis, the upper body portion including a first threaded end distal from the counter bore;
a mandrel including an upper end receivable in the counter bore, the mandrel including a second threaded end distal from the upper end;
a lower cap member engaged with the upper body portion, the lower cap member disposed to secure the upper end of the mandrel in the counter bore;
an internal locking arrangement configured to selectively couple and decouple the upper body portion and the mandrel, said selective coupling and decoupling disposed to correspondingly constrain and allow relative rotation of the upper body portion and the mandrel about the cylindrical axis;
the locking arrangement including a plurality of axial teeth disposed on an outer surface of the upper end of the mandrel and extending radially outward from the cylindrical axis and a plurality of axial teeth disposed in the counter bore of the upper body portion extending radially inward toward the cylindrical axis, the teeth disposed on the mandrel and the teeth disposed on the upper body portion being selectively engageable and disengageable with one another;
wherein said coupling and decoupling of the upper body portion and the mandrel are enabled respectively by urging the mandrel out of the counter bore and urging the mandrel deeper into the counter bore in a direction substantially parallel to the cylindrical axis.

19. The locking swivel apparatus of claim 18, further comprising manual actuation of said coupling and decoupling of the upper body portion and the mandrel.

20. The locking swivel apparatus of claim 18, being coupleable to a drill string.

21. The locking swivel apparatus of claim 20, wherein the first threaded end is couplable to an upper section of the drill string.

22. The locking swivel apparatus of claim 20, wherein the second threaded end is couplable to a lower section of the drill string.

23. The locking swivel apparatus of claim 18, wherein the mandrel further comprises a flange extending outward from an outer surface thereof.

24. The locking swivel apparatus of claim 23, wherein the flange abuts a lower face of the upper body portion when the upper body portion and the mandrel are in a decoupled position.

25. The locking swivel apparatus of claim 24, further comprising a ring member interposed between the flange and the lower face of the upper body portion.

26. The locking swivel apparatus of claim 23, wherein the flange abuts a shoulder portion of the cap member when the upper body portion and the mandrel are in a coupled position.

27. The locking swivel apparatus of claim 18, wherein said engagement of the teeth disposed on the mandrel and the teeth disposed on the upper body portion with one another enables said coupling of the upper body portion and the mandrel.

28. The locking swivel apparatus of claim 18, wherein said disengagement of the teeth disposed on the mandrel and the teeth disposed on the upper body portion with one another enables said decoupling of the upper body portion and the mandrel.

29. The locking swivel apparatus of claim 18, further comprising a brass sleeve disposed in lower cap member.

30. A method for selectively constraining or allowing relative rotation of lower and upper sections of a drill string, the method comprising:
(a) providing a locking swivel apparatus including:
an upper body portion having a counter bore about a cylindrical axis, the upper body portion including a first threaded end distal from the counter bore;
a mandrel including an upper end, the upper end being receivable in the counter bore, the mandrel including a second threaded end distal from the upper end;
a lower cap member engaged with the upper body portion, the lower cap member disposed to secure the upper end of the mandrel in the counter bore;
an internal locking arrangement configured to selectively couple and decouple the upper body portion and the mandrel, said selective coupling and decoupling disposed to correspondingly constrain and allow relative rotation of the upper body portion and the mandrel about the cylindrical axis; and
the locking arrangement including a plurality of axial teeth disposed on an outer surface of the upper end of the mandrel and extending radially outward from the cylindrical axis and a plurality of axial teeth disposed in the counter bore of the upper body portion extending radially inward toward the cylindrical axis, the teeth disposed on the mandrel and the teeth disposed on the upper body portion being selectively engageable and disengageable with one another.
(b) coupling the lower section of the drill string to the mandrel;
(c) coupling the upper section of the drill string to the upper body portion; and
(d) selectively operating the locking arrangement to enable said selective coupling and decoupling of the upper body portion and the mandrel.

31. The method of claim 30 wherein said selectively operating the locking arrangement comprises manually urging the mandrel out of the counter bore and manually urging the mandrel deeper into the counter bore respectively to said selectively couple and decouple the mandrel and the upper body portion.

32. A method for fabricating a locking swivel apparatus, the method comprising:
(a) forming a cylindrical counter bore about a cylindrical axis in an upper body portion, the upper body portion having a first threaded end distal from the counter bore;
(b) forming mandrel having an upper end, the upper end being receivable in the counter bore, the mandrel including a second threaded end distal from the upper end;
(c) forming a lower cap member sized and shaped for threadable engagement with the upper body portion;
(d) forming a first plurality of axial teeth on an outer surface of the upper end of the mandrel, the teeth extending radially outward from the cylindrical axis and a second plurality of axial teeth in the counter bore of the upper body portion extending radially inward toward the cylindrical axis, the first and second plurality of teeth being sized and shaped for selective engagement and disengagement with one another;
(e) positioning the mandrel in the counter bore such that selective reciprocation of the mandrel and the upper body portion along the cylindrical axis causes corresponding coupling and decoupling of the upper body portion and the mandrel via said selective engagement and disengagement of the teeth on the mandrel and the teeth in the counter bore, said coupling and decoupling of the upper body portion and the mandrel correspondingly constraining and allowing relative rotation of the upper body portion and the mandrel about the cylindrical axis.
(f) threading the lower cap member to the upper body portion, the lower cap member disposed to secure the upper end of the mandrel in the counter bore.
